(19) United States
(12) Patent Application Publication
(10) Pub. No.: US 2018/0105668 A1
(43) Pub. Date: Apr. 19, 2018

(54) METHODS OF ISOLATING MELT-PROCESSIBLE POLYCARBONATE FROM PLASTIC WASTE, METHODS OF PREPARING POLYCARBONATE-CONTAINING HYBRID POLYMERS, AND COMPOSITIONS COMPRISING SAME

(71) Applicant: THE REGENTS OF THE UNIVERSITY OF COLORADO, A BODY CORPORATE, DENVER, CO (US)

(72) Inventors: WIL V. SRUBAR, BOULDER, CO (US); WEI ZHANG, SUPERIOR, CO (US)

(21) Appl. No.: 15/297,536

(22) Filed: Oct. 19, 2016

(51) Int. Cl. C08J 11/08; C08J 5/18; C08L 69/00; C08L 61/22

(52) U.S. Cl. CPC C08J 11/08; C08J 5/18; C08J 2369/00; C08L 61/22; C08L 69/00

(57) ABSTRACT

This invention provides methods to separate polycarbonates from plastic swarf. The present invention further provides methods of generating novel materials from post-processing polymers.

### BACKGROUND OF INVENTION

Plastic is generally a non-biodegradable material, and thus used or worn-out plastic may create great waste problems. In fact, about eight million metric tons of waste plastic enter the Earth's ocean every year. Post-consumer plastics recycling lags far behind recycling of newspapers (about 80%) and corrugated fiberboard (about 70%). In 2008, U.S. post-consumer plastic waste was estimated to be 33.6 million tons; of that amount, only 6.5% were recycled, while 7.7% were burned for energy and the vast majority (85.5%) was discarded in landfills.

Plastic recycling comprises recovering scrap or waste plastic and reprocessing the material into useful products, and this helps to reduce the high rates of plastic pollution. The recycling process generally starts with sorting plastic waste into different polymer types, and then chipping and melting each polymer type into reusable pellets.

Compared with lucrative recycling of metal, plastic polymer recycling is challenging because of the low density and low value of plastics. Furthermore, plastic recycling is associated with various yet-unconquered technical hurdles, such as separation of mixed polymers and economical impurity removal.

Plastic is made of polymeric macromolecules, and often comprises mixtures of such macromolecules. Thus, any kind of recycling has to take into account that the individual polymers comprising the plastic may have to be separated. Another barrier to widespread plastic recycling is the common use of dyes, fillers, and other additives in plastics. Separation of fillers is hampered by the intrinsic viscosity of plastics, and processes that could be used to remove the added dyes would damage the plastic. Additives are less widely used in beverage containers and plastic bags, allowing them to be recycled more often. Another barrier to removing large quantities of plastic from the waste stream and landfills is the fact that many common plastic items lack the universal triangle recycling symbol and accompanying number, hampering identification of the polymeric material used in such items. Examples are the billions of plastic utensils commonly used at home or in fast food restaurants, which generally go unrecycled.

Typical types of plastics used in consumer products include polyethylene terephthalate (PET or PETE), high-density polyethylene (HDPE), polyvinyl chloride (PVC), low-density polyethylene (LDPE); polypropylene (PP), polystyrene (PS), polycarbonates (PCs), and ABS (acrylonitrile, butadiene and styrene). Polycarbonates are a group of thermoplastic polymers containing carbonate groups in their chemical structures, and form strong plastics, which may be optically transparent. Polycarbonates are easily worked, molded, and thermoformed. They have high impact-resistance but low scratch-resistance, thus requiring the application of a hard coating polycarbonate eyewear lenses and polycarbonate exterior automotive components. The characteristics of polycarbonate compare well to those of polymethyl methacrylate (PMMA or acrylic), but polycarbonate is stronger and holds up longer to extreme temperature. Polycarbonate is highly transparent to visible light, with better light transmission than many kinds of glass. Products made from polycarbonates can contain the precursor monomer bisphenol A (BPA or 4,4′-(propane-2,2-diyl)diphenol), and are known by a variety of trademarked names, including LEXAN®, MAKROLON®, HAMMERGLASS® and others.

There is a need in the art for novel and versatile methods of recycling post-consumer plastics, including those comprising polycarbonates. Such methods should allow for isolation of polycarbonates from plastic swarf, and further allow for post-processing product formation. The present invention meets these needs.

### BRIEF DESCRIPTION OF THE DRAWINGS

For the purpose of illustrating the invention, there are depicted in the drawings certain embodiments of the present invention. However, the invention is not limited to the precise arrangements and instrumentalities of the embodiments depicted in the drawings.

FIG. 1 comprises a non-limiting fluxogram illustrating a method of the invention.

FIG. 2 comprises a non-limiting illustration of a Soxhlet extraction set-up.

FIG. 3 comprises a non-limiting illustration of extraction of polycarbonates from plastic swarf according to a method of the invention.

FIG. 4 comprises non-limiting images illustrating production of a recycled polycarbonate film (right) from plastic swarf (left). Polycarbonates were extracted from the plastic swarf using a Soxhlet. The polycarbonates were dissolved in dichloromethane, and the solution was slowly evaporated from a beaker at room temperature.

FIG. 5 comprises illustrative images of self-healing polycarbonate-polyimine hybrids of the invention.

FIG. 6 comprises illustrative images of self-healing polycarbonate-polyimine hybrids of the invention. The hybrid materials contained 25 wt % (left) or 33 wt % (right) polycarbonate. No discernable interface was observed in either case.

FIG. 7 comprises graphs illustrating differential scanning calorimetry (DSC) analysis of raw polycarbonate-containing plastic swarf. The curves, obtained after the volatiles had been eliminated, show no prominent melting features, indicating that direct thermal reprocessing of raw swarf was not feasible.

FIG. 8 comprises graphs illustrating thermogravimetric analysis (TAG) analysis of raw polycarbonate-containing plastic swarf. The curves indicate high degradation temperatures.

FIG. 9 comprises graphs illustrating differential scanning calorimetry (DSC) analysis of various polycarbonate (PC)-polyimine (PI) hybrid polymers. The curves show thermal features, indicating glass transitions.

FIG. 10 comprises bar graphs illustrating dynamic mechanical analysis (DMA) of polycarbonate-polyimine hybrid materials in terms of elastic modulus. The hybrid materials contain different ratio of PC and PI. The materials were pressed under 45 MPa, either at room temperature (RT) or at 70° C., for 12 hours before DMA tests.

FIG. 11 comprises bar graphs illustrating dynamic mechanical analysis (DMA) of polycarbonate-polyimine hybrid materials in terms of glass transition temperature. The hybrid materials contain different ratio of PC and PI. The materials were pressed under 45 MPa, either at room temperature (RT) or at 70° C., for 12 hours before DMA tests.

### DETAILED DESCRIPTION OF INVENTION

The present invention relates in part to the unexpected discovery of methods of separating polycarbonates from plastic swarf. The present invention further relates to the unexpected discovery of methods of generating novel materials from post-processing polymers.

### Definitions

The definitions used in this application are for illustrative purposes and do not limit the scope used in the practice of the present invention.

Unless defined otherwise, all technical and scientific terms used herein generally have the same meaning as commonly understood by one of ordinary skill in the art to which this invention belongs. Generally, the nomenclature used herein and the laboratory procedures in organic chemistry, chemical engineering and polymer chemistry are those well-known and commonly employed in the art.

As used herein, the articles “a” and “an” are used herein to refer to one or to more than one (i.e., to at least one) of the grammatical object of the article. By way of example, “an element” means one element or more than one element.

As used herein, the term “about” will be understood by persons of ordinary skill in the art and will vary to some extent on the context in which it is used. As used herein, “about” when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

As used herein, the term “container” includes any receptacle for holding a composition. For example, in certain embodiments, the container is the packaging that contains the composition. In other embodiments, the container is not the packaging that contains the composition, i.e., the container is a receptacle, such as a box or vial that contains the packaged composition or unpackaged composition and the instructions for use of the composition. Moreover, packaging techniques are well-known in the art. It should be understood that the instructions for use of the composition may be contained on the packaging containing the composition, and as such the instructions form an increased functional relationship to the packaged product. However, it should be understood that the instructions can contain information pertaining to the compound's ability to perform its intended function.

“Instructional material,” as that term is used herein, includes a publication, a recording, a diagram, or any other medium of expression that can be used to communicate the usefulness of a composition of the present invention in a kit. The instructional material of the kit may, for example, be affixed to a container that contains a composition of the present invention or be shipped together with a container that contains a composition. Alternatively, the instructional material may be shipped separately from the container with the intention that the recipient uses the instructional material and a composition cooperatively. Delivery of the instructional material may be, for example, by physical delivery of the publication or other medium of expression communicating the usefulness of the kit, or may alternatively be achieved by electronic transmission, for example by means of a computer, such as by electronic mail, or download from a website.

As used herein, the term “plastic swarf” refers to pieces, debris, chips, turnings, filings, or shavings of plastic or waste plastic. In certain embodiments, plastic swarf can be any residue produced during the processing of polycarbonates in industry, such as in production, processing or disposal of prescription lens. In such embodiments, plastic swarf comprises polycarbonates, as well as contaminants including metal shavings, tape, CR-39 resins coolant, and so forth. Such waste may also contain bisphenol A (BPA).

As used herein, the term “polyaldehyde” refers to a compound containing two or more aldehyde groups. Examples of polyaldehydes contemplated within the disclosure include, but are not limited to, dialdehydes (such as, but not limited to, glyoxal, malonaldehyde, glutaraldehyde, 2,3-thiophenedicarbaldehyde, 2,5-thiophene-dicarbaldehyde, 3-formylfurfural, 5-formylfurfural, 2,6-pyridinedicarboxaldehyde, 3,6-pyridinedicarboxaldehyde, 3,5-pyridinedicarboxaldehyde, isophthaldehyde, terephthaldehyde [such as 1,4-terephthalaldehyde (p-phthalaldehyde)], phthaldialdehyde, phenylglyoxal, and pyrroledicarboxaldehyde), multivalent aldehydes (such as, but not limited to, benzene-1,3,5-tricarboxaldehyde, 2,4,6-trihydroxy-1,3,5-benzenetricarboxaldehyde), and monomers comprising at least one primary amine and at least one aldehyde group (such as 4-aminobenzaldehyde, or 4-aminomethylbenzaldehyde).

As used herein, the term “polyamine” refers to a compound containing two or more (primary or secondary) amino functionalities. In certain embodiments, the amine monomer comprises two primary or secondary amine groups. In other embodiments, the amine monomer comprises three, four or more primary or secondary amine groups. Examples of amine monomers contemplated within the disclosure include, but are not limited to, diamines (such as, but not limited to, hydrazine, ethylenediamine, propylenediamine, 1,4-diaminobutane, 1,5-diaminopentane, 1,6-diaminohexane, 1,7-diaminoheptane, 1,8-diaminooctane, 1,9-diaminononane, 1,10-diaminodecane, 1,12-diaminododecane, 3,3′-diamino-N-methyl-dipropylamine, phenylenediamine, phenylenedimethylenamine, diaminocyclohexane, diaminocyclopentane, diaminocyclobutane, diaminothiophene, diaminopyridine, diaminopyrrole, diaminofuran, diaminoimidazole, diaminooxazole, 3,6,9-trioxaundecan-1,11-diamine, and diethylenetriamine), multivalent amines (such as, but not limited to, tris(2aminoethyl)amine, 3-ethylamino-1,5-diaminopentane, triaminobenzene, and triaminocyclohexane), and monomers comprising at least one primary amine and at least one carbonyl group (such as 4-aminobenzaldehyde, or 4-aminomethylbenzaldehyde).

As used herein, the term “polycarbonate” or “PC” refers to a general classification of polymers that contain carbonate groups in their structures. In certain embodiments, the PC comprises bisphenol A (BPA) as a monomeric structure (or building block). A BPA-PC can be prepared by polymerization between bisphenol A and phosgene, or bisphenol A and diphenyl carbonate. Suitable replacement for bisphenol A include 1,1-bis(4-hydroxyphenyl)cyclohexane, dihydroxybenzophenone, tetrabromobisphenol A and tetramethylcyclobutanediol. Polycarbonates generally have a glass transition temperature of about 147° C., softening above this point and flowing above about 155° C.

As used herein, the term “polymer” refers to a molecule composed of repeating structural units typically connected by covalent chemical bonds. The term “polymer” is also meant to include the terms monomers, copolymers and oligomers. In certain embodiments, a polymer comprises a backbone (i.e., the chemical connectivity that defines the central chain of the polymer, including chemical linkages among the various polymerized monomeric units) and a side chain (i.e., the chemical connectivity that extends away from the backbone).

As used herein, the term “polymerization” or “cross-linking” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combinations thereof. A polymerization or cross-linking reaction may consume between about 0% and about 100% of the at least one functional group available in the system. In an embodiment, polymerization or cross-linking of at least one functional group results in about 100% consumption of the at least one functional group. In another embodiment, polymerization or cross-linking of at least one functional group results in less than about 100% consumption of the at least one functional group.

As used herein, the term “virgin plastic” refers to plastic that has not been previously used or consumed, or subjected to processing apart from its original production, or recycled by any process or method.

Throughout this disclosure, various aspects of the present invention can be presented in a range format. It should be understood that the description in range format is merely for convenience and brevity and should not be construed as an inflexible limitation on the scope of the present invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Disclosure

The invention provides novel methods of separating polycarbonates (PCs) from plastic swarf. In certain embodiments, the plastic swarf contemplated within the invention comprises pieces, debris, chips, turnings, filings, or shavings of plastic or waste plastic. In other embodiments, the plastic swarf can be any residue produced during the processing of polycarbonates in the prescription lens laboratories. In yet other embodiments, the swarf comprises bisphenol A (BPA)-based PCs, also known as BPA-PC. The methods of the invention allow for recovery of BPA-PC, which can be extruded, 3D printed, or hot-pressed. Further, the recovered BPA-PC can be transformed in optically transparent films. The invention further provides novel methods of preparing hybrid self-healing polymers using PC (such as BPA-PC, which can comprise recovered and/or virgin PC) and polyimines.

Non-limiting examples of physical properties of exemplary films and polymers obtained using the methods of the invention compare favorably to those observed for ABS and virgin PCs, as demonstrated in Table 1.

TABLE 1

| | Glass | | Upper | | |
|---|---|---|---|---|---|
| | Transition | Melting | Working | Young's | |
| | Temperature | Temperature | Temperature | Modulus | |
| ABS | 105° C. | degradation onset | 80° C. | 1.4-3.1 | GPa |
| | | ~350° C. | | | |
| PLA | 60-65° C. | 173-178° C. | 45-50° C. | ~3.5 | GPa |
| Virgin PC | 147° C. | 225° C. | 115-130° C. | ~2.6 | GPa |
| Recycled PC film | 143° C. | degradation onset | 115-130° C. | 15-25 | MPa |
| | | 270-400° C. | | | |
| Recycled PC filament | 145° C. | degradation onset | 115-130° C. | ~800 | MPa |
| | | ~450° C. | | | |
| *PC-Polyimine films | 70-95° C. | >300° C. | 60-80° C. | 170-2150 | MPa |

*values dependent on imine content and temperature processing condition

In one aspect, the invention provides novel methods of separating polycarbonates (PCs) from plastic swarf. Plastic swarf may contain impurities, such as but not limited to tape (such as but not limited to Ceraguard Blue Linerless), coolant (such as but not limited to LH-305), surface alloy (such as but not limited to 117 degree alloy), dyes, pigments, residual moisture, and manufacturer-dependent mixes of polymeric material. Non-limiting examples of swarf constituents are illustrated in Tables 2-3. Further, plastic swarf may contain polymeric materials, such as but not limited to polycarbonates, CR-39 (also known as diallyl diglycol carbonate), Trivex (such as but not limited to polyurethane-polyurea, alliphatic polysulfide, polythiourethane), Hi-index (such as but not limited to thiourethanes) and Mid-index, or other proprietary polymer mixtures. The swarf material to be processed may be analyzed using conventional polymer characterization methods, such as, but not limited to, nuclear magnetic resonance (NMR), gel permeation chromatography (GPC), elemental analysis, energy-dispersive X-ray spectroscopy (EDS, EDX, or XEDS), scanning electron microscopy, and the like.

TABLE 2
Maui Jim Swarf Constituents

| Material | Category | Supplier |
|---|---|---|
| Younger Polycarbonate | Lens Material | Younger |
| Lenses | | Optics |
| Hi-Index | Lens Material | |
| LH-305 Plus | Coolant; Triethanolamine, | Satisloh |
| | amine borate | |
| Wrapper Tape-Clear 451 | Tape; | Venture |
| | (two or more) paper, plastic | Tape |
| | film, aluminum foil, | |
| | reinforcing yarn, adhesive | |

TABLE 3
Essilor DBL Swarf Materials

| Material | Category | Supplier |
|---|---|---|
| Ceraguard Blue Linerless | tape | |
| LH-305 Precision Opthalmic | Coolant; | Satisloh |
| Lens Generation Fluid | Ethanolamine, triethanolamine, | |
| | boron sodium oxide, boric acid | |
| Poly Lube LH-205 | Ethylene oxide, methyl-, | Satisloh |
| | polymer | |
| 117 degree alloy | | |
| Cr-39 | Lens Material | |
| Hi-Index | Lens Material | |
| Trivex | Lens Material | |

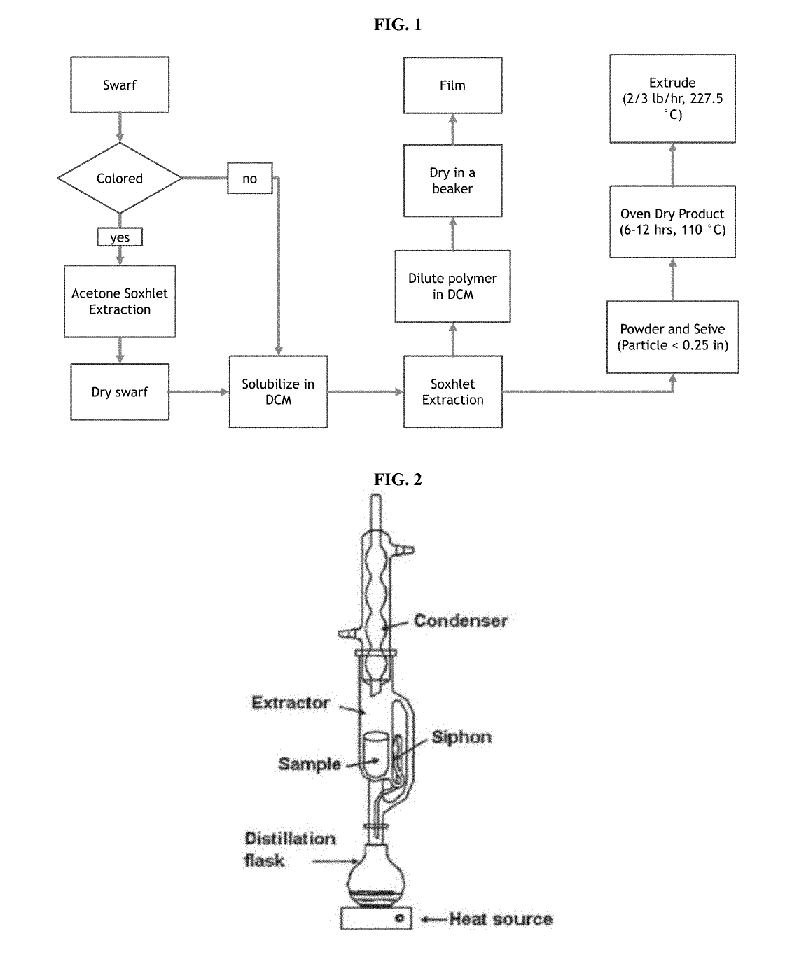

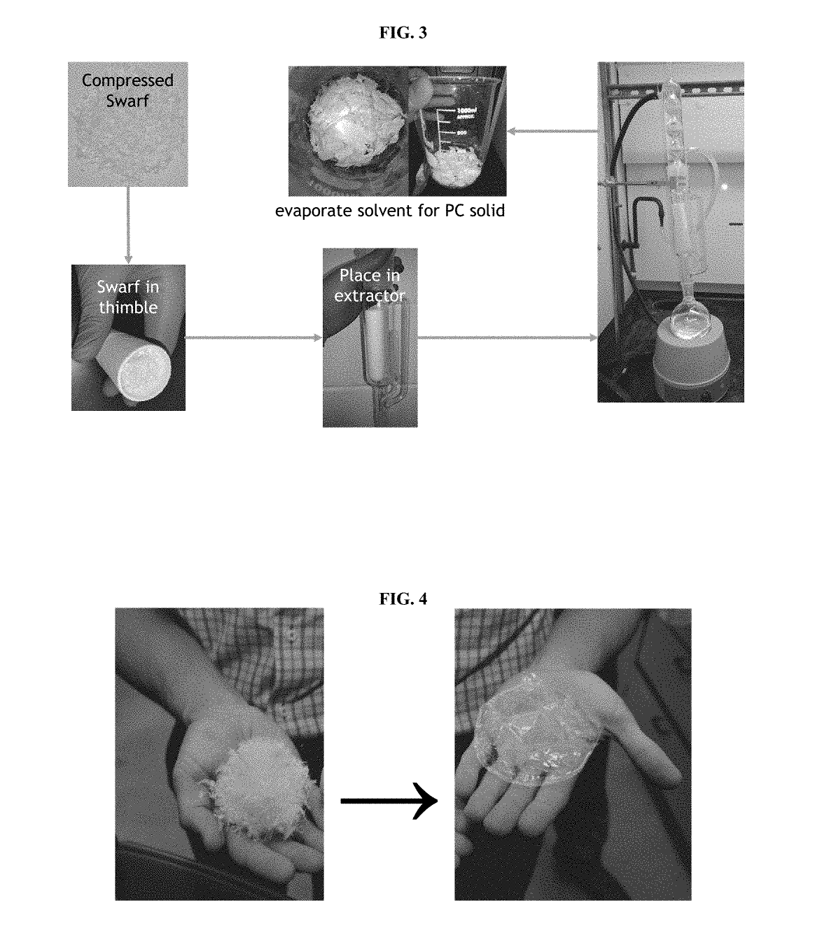

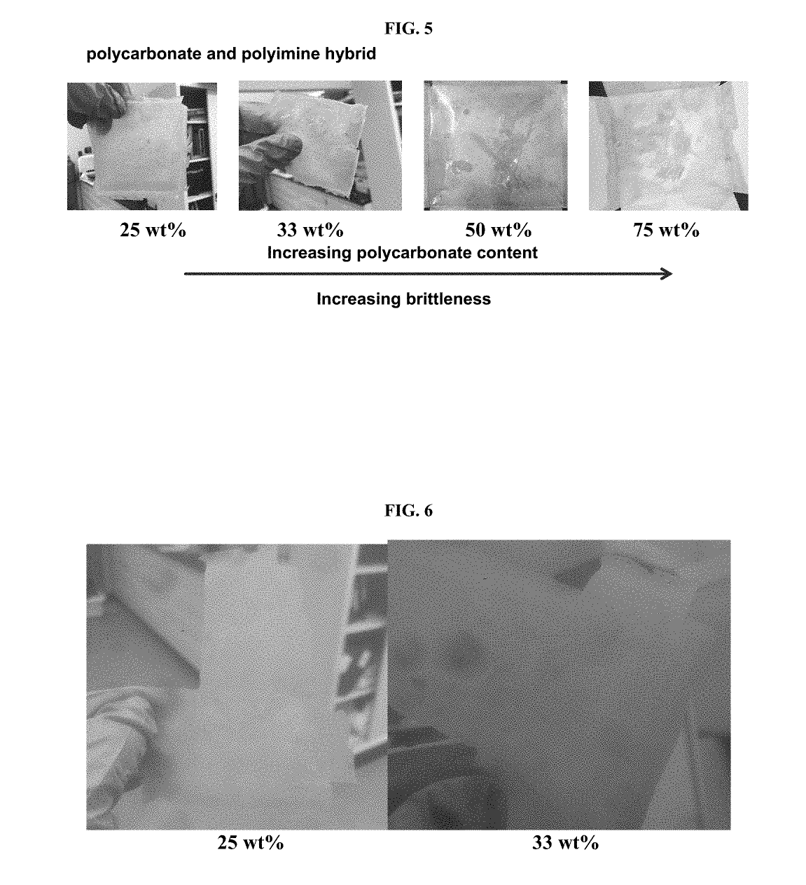

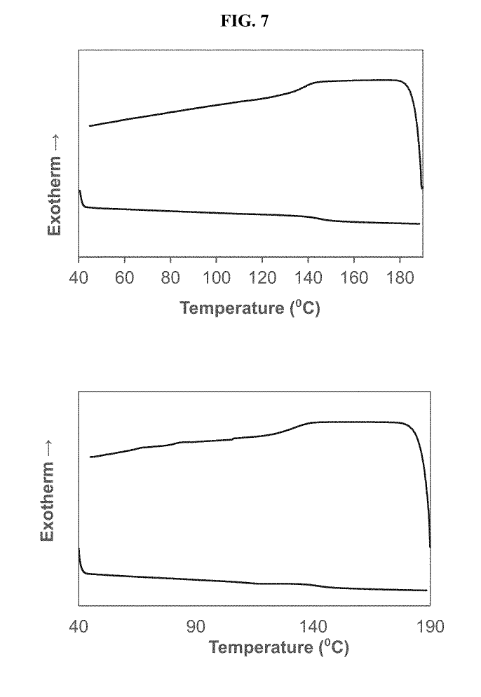

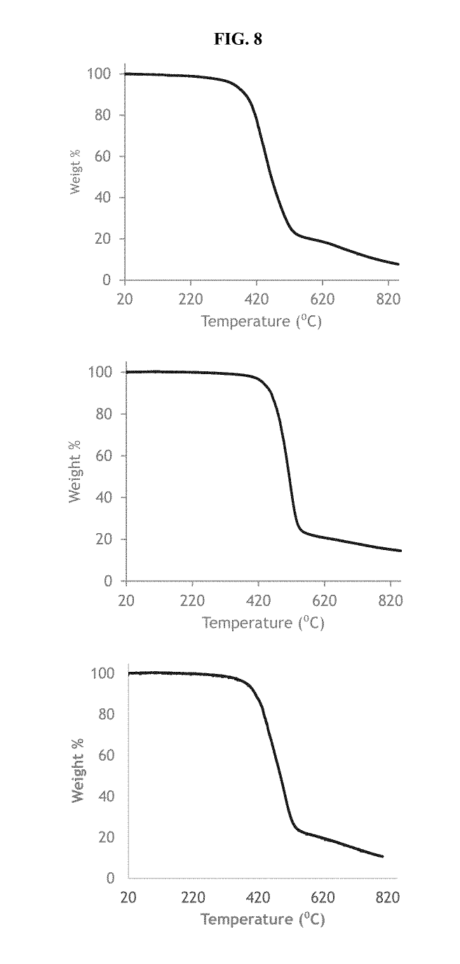

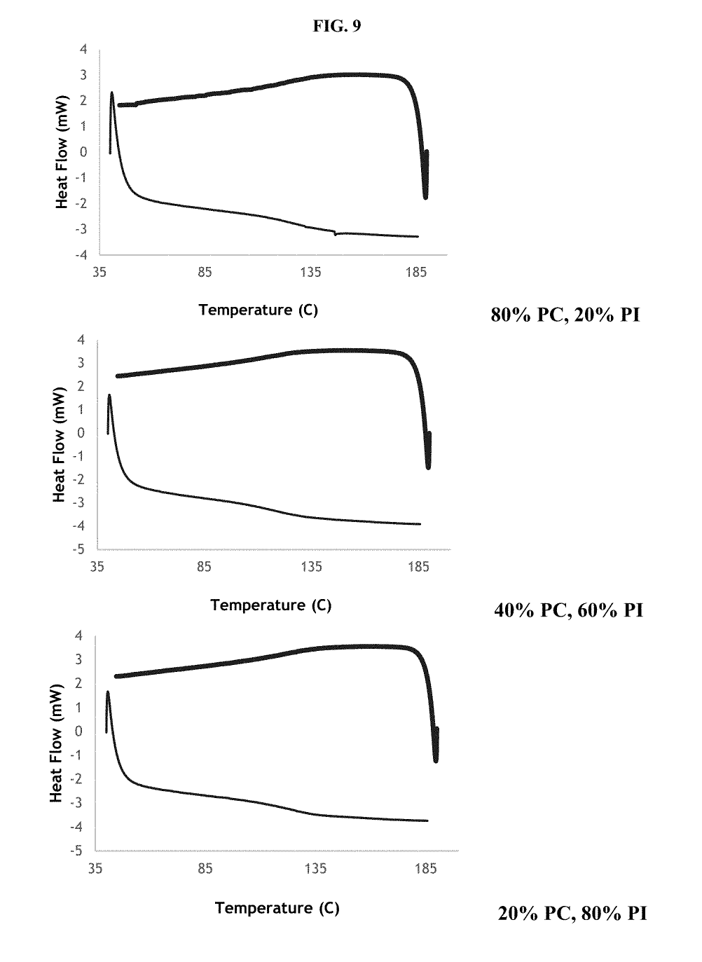

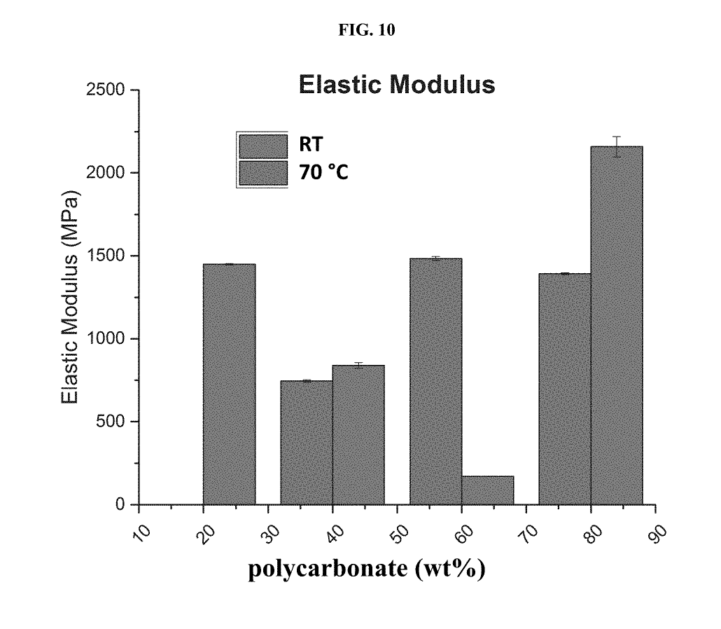

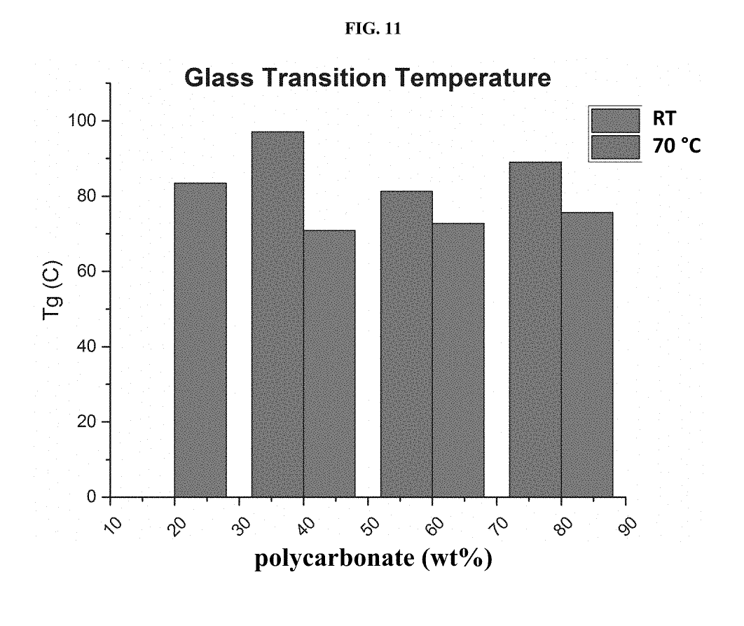

A non-limiting method of the invention for purifying polycarbonates from plastic swarf is illustrated in FIG. 1. The plastic swarf can be visually analyzed for traces of color. If color is detected, the colored impurities can be extracted from the plastic swarf with solvents, such as, but not limited to, acetone, butanone, methyl isopropyl ketone, methyl isobutyl ketone, ethyl isopropyl ketone, 2-pentanone, 3-pentanone, 2-hexanone, cyclopentanone, or other ketones, or any mixtures thereof, using a Soxhlet set-up (FIG. 2), or any equivalent set-up. In general terms, the plastic swarf is contained in a first reservoir, where it is contacted with hot purifying solvent (which can be generated by condensing purifying solvent vapor on a condenser, which is positioned such that the condensed purifying solvent makes contact with the plastic swarf). The condensed purifying solvent can be removed from the first reservoir into a separate reservoir (which can be the reservoir from which the purifying solvent is being heated to boiling, or it can be a distinct reservoir), leaving the extracted swarf in the first reservoir. The extracted swarf can be re-extracted with hot purifying solvent as many times as necessary to achieve the desired purity level. It should be noted that the plastic swarf can be extracted with the purifying solvent even if it does not contain visible colored impurities.

Alternatively, the plastic swarf can be treated with chloroform, and any non-soluble residue is discarded. The chloroform solution is evaporated, providing a purified swarf.

Alternatively, the plastic swarf can be washed with an aqueous acidic solution (such as hydrochloric acid, such as but not limited to 1 N HCl), and the solid can be filtered and washed with water until the acid residue is removed. The solid comprises a purified swarf.

It should be noted that any of the purifying procedures described herein can be combined with one another, in any possible sequence and with any number of individual repetitions, until the desired purity level of the plastic swarf is achieved.

Once the plastic swarf is extracted with the purifying solvent and/or purified by any other means to the operator's satisfaction, the swarf is then dried (for example, by exposure to air, heat, flowing gas, and any combinations thereof), yielding processed swarf. Alternatively, the raw plastic swarf is used within the methods of the invention.

The plastic swarf is then extracted with a solvent such as, but not limited to, dichloromethane (DCM), tetrahydrofuran (THF), 1,2-dichloroethane, 1,4-dioxane, dimethylformamide (DMF), dimethylacetamide (DMA), benzene, toluene, xylene and/or chlorobenzene, which extracts polycarbonates from the plastic swarf. This extraction can be performed using a Soxhlet set-up, or any equivalent set-up. In general terms, the swarf is contained in a first reservoir, where it is contacted with a hot extracting solvent (which can be generated by condensing solvent vapor on a condenser, such that the hot condensed solvent makes contact with the swarf). The solvent can be removed from the first reservoir into a separate reservoir (which can be the reservoir from which the solvent is being heated to boiling, or it can be a distinct reservoir), leaving the swarf in the first reservoir. The swarf can be re-extracted with hot extracting solvent as many times as necessary to extract the desired amount of polycarbonates from the swarf. The polycarbonate-containing solutions can be combined and/or concentrated to isolate the extracted polycarbonate therein. Alternatively, the polycarbonate-containing solutions can be submitted to subsequent purification procedures to remove any impurity that was also extracted from the swarf using the hot solvent procedure.

In certain embodiments, the polycarbonate-containing solutions can be used to generate a polycarbonate film, which is certain embodiments is substantially or fully transparent. The polycarbonate-containing solutions can comprise dichloromethane, tetrahydrofuran, chloroform, 1,2-dichloroethane, 1,4-dioxane, benzene and/or toluene. In certain embodiments, the polycarbonate-containing solutions comprise dichloromethane and/or tetrahydrofuran as the only solvent(s). For example, the polycarbonate-containing solutions can be diluted with dichloromethane or any other suitable solvent as necessary, or concentrated as necessary, to the desired concentration of polycarbonate in the solution. Alternatively, the polycarbonate-containing solutions can be used as is, without dilution and/or concentration. The solutions can then be allowed to evaporate from a container, or submitted to mild heating and/or low pressure, to remove solvents in a slow rate, thus generating a polycarbonate film within the container.

In certain embodiments, the polycarbonate-containing solutions can be used to generate extruded polycarbonate. For example, the polycarbonate-containing solutions can be concentrated to dryness, or near dryness, to generate solid polycarbonate residue, which can be reduced to powder. That powder can be further sieved as needed, to obtain polycarbonate powder of desired diameter. In certain embodiments, the desirable polycarbonate powder has a diameter than is equal to or lower than 0.25 inches. The resulting polycarbonate solid is then dried, for example in an oven or similar set-up, and then extruded as desired, for example, as filaments.

In one aspect, the invention provides novel methods of preparing hybrid self-healing polymers using recovered BPA-PC. In certain embodiments, a polycarbonate solution is contacted with a polyimine solution, to form a reaction mixture. In other embodiments, a polycarbonate solution comprises polycarbonate extracted from plastic swarf using, in non-limiting manner, any of the methods described elsewhere herein. In yet other embodiments, the polyimine solution is formed by dissolving a pre-formed polyimine polymer in an appropriate solvent. In yet other embodiments, the polyimine solution is formed in situ by contacting at least one polyaldehyde and at least one polyamine in solution. The ratio of the polycarbonate and the polyimine can be varied as desired, from a ratio of about 1:99 to about 99:1, from a ratio of about 10:90 to about 90:10, from a ratio of about 20:80 to about 80:20, from a ratio of about 25:75 to about 75:25, and any ratio thereinbetween. In certain embodiments, the ratio of polycarbonate and the polyimine is about 1:99, 5:95, 10:90, 20:80, 25:75, 30:70, 33:67, 40:60, 50:50, 60:40, 67:33, 70:30, 75:25, 80:20, 90:10, 95:5, 99:1, or any ratio thereinbetween. The resulting hybrid polymer can be isolated from the reaction mixture by concentration, evaporation, extraction, solvent-aided precipitation, size-exclusion chromatography, or any other method known in the art.

### Methods

The invention provides a method of separating polycarbonate from a polycarbonate-containing plastic swarf. In certain embodiments, the method comprises (a) contacting a polycarbonate-containing plastic swarf sample with a first volume of a solvent comprising dichloromethane (DCM), tetrahydrofuran (THF), 1,2-dichloroethane, 1,4-dioxane, dimethylformamide (DMF), dimethylacetamide (DMA), benzene, toluene, xylene and/or chlorobenzene, thus forming a mixture comprising a supernatant and a solid residue. In other embodiments, the method comprises (b) separating the supernatant from the solid residue, wherein the supernatant comprises at least a fraction of the polycarbonate comprised in the plastic swarf sample.

In certain embodiments, the polycarbonate-containing plastic swarf melts with at least partial decomposition. In other embodiments, the polycarbonate-containing plastic swarf undergoes no significant melting. In yet other embodiments, the polycarbonate-containing plastic swarf undergoes only partial melting.

In certain embodiments, the solid residue in (b) is subjected to one or more cycles of steps (a)-(b), wherein for each cycle the supernatant in (b) comprises at least a fraction of the polycarbonate comprised in the plastic swarf sample and the solid residue in (b) is used as the sample in step (a) of the next cycle, if applicable.

In certain embodiments, the supernatants separated in each cycle are combined to generate a polycarbonate-containing solution. In other embodiments, the solid residue in (b) is subjected to one or more cycles of steps (a)-(b) until the weight of the solid residue remains approximately the same after two consecutive cycles.

In certain embodiments, the plastic swarf comprises at least one selected from the group consisting of bisphenol A, 1,1-bis(4-hydroxyphenyl)cyclohexane, dihydroxybenzophenone, tetrabromobisphenol A and tetramethylcyclobutanediol.

In certain embodiments, the solvent in (a) at a temperature ranging from room temperature to about the solvent's boiling point. In other embodiments, the solvent in (a) at a temperature of about the solvent's boiling point. In yet other embodiments, the polycarbonate-containing plastic swarf sample is in a container that is permeable to the solvent but not to the sample or solid residue, thus allowing for the filtration of the supernatant off the sample or solid residue. In yet other embodiments, the solvent is heated in a reservoir thus forming solvent vapor, and wherein the solvent vapor is condensed onto the sample. In yet other embodiments, the supernatant is drained into the reservoir. In yet other embodiments, the method uses a Soxhlet extraction set-up.

In certain embodiments, the supernatant is at least partially concentrated to provide solid polycarbonate. In other embodiments, the solid polycarbonate is suitable for at least one selected from the group consisting of extrusion, 3D printing and hot pressing. In yet other embodiments, the concentration allows for formation of a transparent polycarbonate film. In yet other embodiments, the concentration comprises solvent evaporation at about atmospheric pressure.

In certain embodiments, before implementing step (a), the plastic swarf is contacted with a purifying solvent to form a solution and a solid residue, wherein the solid residue was dried and used as the sample in step (a). In other embodiments, before implementing step (a), the plastic swarf is contacted with chloroform to form a chloroform-containing solution, wherein any non-soluble residue present is discarded and wherein the chloroform-containing solution is concentrated to provide the sample in step (a). In yet other embodiments, before implementing step (a), the plastic swarf is washed with an aqueous acidic solution and then used as the sample in step (a). In yet other embodiments, the solid residue is substantially free of color.

The invention further provides a method of preparing a transparent polycarbonate film. In certain embodiments, the method comprises allowing a polycarbonate solution in at least one selected from the group consisting of dichloromethane, tetrahydrofuran, chloroform, 1,2-dichloroethane, 1,4-dioxane, benzene and toluene to evaporate, whereby a transparent polycarbonate film forms. In other embodiments, the polycarbonate solution is prepared from plastic swarf using any method of the present invention. In yet other embodiments, the plastic swarf is contacted with at least one selected from the group consisting of dichloromethane, tetrahydrofuran, chloroform, 1,2-dichloroethane, 1,4-dioxane, benzene and toluene, and the resulting solution is used to prepare the transparent polycarbonate film as described elsewhere herein. Any precipitate or solid residue observed upon formation of the solution can be removed by filtration, decantation, centrifugation or equivalent physical method.

The invention further provides a method of forming a hybrid polycarbonate-polyimine material. In certain embodiments, the method comprises contacting a polycarbonate with a polyimine in a reaction solution. In other embodiments, the polyimine is formed in situ by contacting a polyaldehyde with a polyamine in the reaction solution. In yet other embodiments, the polyimine is preformed by contacting a polyaldehyde with a polyamine and then added to the reaction solution. In yet other embodiments, the polyamine is at least one selected from the group consisting of hydrazine, ethylenediamine, propylenediamine, 1,4-diaminobutane, 1,5-diaminopentane, 1,6-diaminohexane, 1,7-diaminoheptane, 1,8-diaminooctane, 1,9-diaminononane, 1,10-diaminodecane, 1,12-diaminododecane, 3,3′-diamino-N-methyl-dipropylamine, phenylenediamine, phenylenedimethylenamine, diaminocyclohexane, diaminocyclopentane, diaminocyclobutane, diaminothiophene, diaminopyridine, diaminopyrrole, diaminofuran, diaminoimidazole, diaminooxazole, 3,6,9-trioxaundecan-1,11-diamine, diethylenetriamine, tris(2-aminoethyl)amine, 3-ethylamino-1,5-diaminopentane, triaminobenzene, and triaminocyclohexane. In yet other embodiments, the polyaldehyde is at least one selected from the group consisting of glyoxal, malonaldehyde, glutaraldehyde, 2,3-thiophenedicarbaldehyde, 2,5-thiophene-dicarbaldehyde, 3-formylfurfural, 5-formylfurfural, 2,6-pyridinedicarboxaldehyde, 3,6-pyridinedicarboxaldehyde, 3,5-pyridinedicarboxaldehyde, isophthaldehyde, terephthaldehyde], phthaldialdehyde, phenylglyoxal, pyrroledicarboxaldehyde, benzene-1,3,5-tricarboxaldehyde, and 2,4,6-trihydroxy-1,3,5-benzenetricarboxaldehyde. In yet other embodiments, the ratio between the polyaldehyde and polyamine ranges from about 10:90 to about 90:10. In yet other embodiments, the ratio between the polyaldehyde and polyamine ranges from about 25:75 to about 75:25. In yet other embodiments, the polycarbonate is obtained from plastic swarf using any of the methods recited elsewhere herein. In yet other embodiments, the polycarbonate is virgin.

### Kits

The invention also includes a kit comprising a composition of the present invention and an instructional material that describes a method of using the composition of the invention, or preparing yet another composition from the composition of the invention. As used herein, an “instructional material” includes a publication, a recording, a diagram, or any other medium of expression that can be used to communicate the usefulness of the composition of the present invention in the kit to perform any of the methods recited recited herein.

The instructional material of the kit may, for example, be affixed to a container that contains the invention or be shipped together with a container that contains the invention. Alternatively, the instructional material may be shipped separately from the container with the intention that the instructional material and the compound be used cooperatively by the recipient.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

### Example 1

In the present study, Bisphenol-A-containing polycarbonate was separated from plastic lens waste (swarf). Polycarbonate is a thermoplastic and is soluble in dichloromethane (DCM or CH₂Cl₂; CAS Number 75-09-2). The separation of the polycarbonate component from swarf was accomplished via solvent extraction using a Soxhlet apparatus (FIG. 2). The Soxhlet apparatus comprised a round bottom flask attached to an extraction chamber and a condenser. The solvent in the round bottom flask was heated to ebullition, and the resulting vapor passed through the extraction chamber and was condensed when it came in contact with the condenser. The resulting liquid dripped back in to the extraction chamber.

The swarf material used in this experiment was provided as flakes or shavings. The swarf feed was housed in an extraction thimble and placed in the extraction chamber. The thimble was made of high quality filter paper, which was not permeable to solids. The solvent under reflux continually dissolved the soluble component of the flakes or shavings (i.e., polycarbonate), and the siphon delivered the solvent-polycarbonate solution to the round bottom flask once the solvent level reached a particular level in the extraction chamber. When the polycarbonate in the extraction thimble had be extracted to a satisfactory level the heating was stopped, the apparatus was allowed to cool, and the polycarbonate-solvent solution was transferred from the round bottom flask to a beaker. The solvent was allowed to evaporate to obtain solid polycarbonate. In cases where the swarf feed contained colored impurities, the colored pigments were removed in the Soxhlet extractor using acetone before polycarbonate extraction using DCM was carried out.

The temperature in the round bottom flask was maintained close to the boiling point of the solvent (DCM: 39.75±2° C.; acetone: 56±2° C.), and the process was carried out under atmospheric pressure. The pH of the solvent (or solution) was not altered and remained neutral throughout the process.

The time required to substantively separate the polycarbonate component from the swarf depended on the polycarbonate component concentration in the swarf. In a non-limiting example, the procedure to determine that the extractive process was substantively complete comprised recording the weight of the thimble and the swarf within the thimble before initiating the extractive process, and then performing the extractive process. Periodically the thimble and the sample remaining therein were periodically removed from the extraction chamber, dried and weighted. The extractive process was considered to be substantively complete once no further weight loss of the thimble and swarf residue was observed.

### Example 2

The soluble component of the swarf was extracted using DCM and the insoluble residues were removed by vacuum filtration. The clear polymer-DCM solution was then poured into clean beakers and the volatile DCM solvent was allowed to evaporate in the fume hood. The beakers were left undisturbed during the evaporation process so as to obtain transparent films. In certain embodiments, transparent films were obtained when the thickness of the film were kept to a minimum. In other embodiments, the thickness of the films can be manipulated by changing the concentration of the soluble component of the swarf in the DCM solution.

### Example 3

Polycarbonate obtained using the procedure of Example 1 was grinded and sieved so that particle sizes were <0.25 inches (<6.35 mm). Powdered polycarbonate was then spread in 5 mm layers and dried at 110° C. for 6-12 hours to remove all water. When not used immediately, powdered polycarbonate was stored in an airtight container to keep out moisture.

For extrusion (using a Filabot EX2 filament extruder), dried powdered polycarbonate was placed in the extrusion hopper, and the Filabot was heated to 227.5° C. Extrusion speeds were around 0.67 lb/hr to obtain optically clear filament. Most filament extruded was a transparent tan color, indicating impurities, likely a second polymer besides polycarbonate that was also soluble in DCM.

### Example 4

The polycarbonate samples received from Walmart-Indiana contained mainly linear bisphenol A (BPA) based polymer (1), which was soluble in organic solvents, such as but not limited to tetrahydrofuran and/or chloroform. The polycarbonate was then combined with polyimines, which are crosslinked polymer networks that behave like classic thermosets at ambient conditions, but are malleable, reprocessible, and repairable in the presence of water or under heat. In certain embodiments, the hybrids of polyimine and polycarbonates have significantly enhanced mechanical properties and self-healing ability.

In a non-illustrative example, polycarbonate sample (Walmart Indiana) was dissolved in tetrahydrofuran (sonication for 2 h). To the solution of the polycarbonate was added diamine 2 and triamine 3 with stirring. The aldehyde 4 was then added, and the solution was poured into premade 8×8×6 cm silica paper box. The experimental setup was then kept in the fume hood overnight, by when the volatiles were evaporated to provide the hybrid materials as thin films. The film was then heat-pressed at about 76.7° C. (170° F.). Total four formulas were tested with the weight ratio of polycarbonate and polyimine: 25:75, 33:66, 50:50, 75:25.

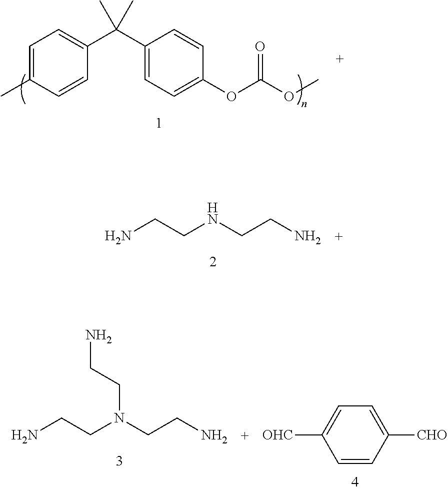

The material obtained with each ratio of polycarbonate and polyimine was heated and pressed to obtain a film, and the resulting film was tested for self-healing properties. Experimentally, it was observed that materials comprising 25 wt % or 33 wt % polycarbonate materials were healable with no discernable interface. Further, materials comprising 50 wt % and 75 wt % polycarbonate samples were also healed, but the break point was visible if the material was bent.

The disclosures of each and every patent, patent application, and publication cited herein are hereby incorporated herein by reference in their entirety. One skilled in the art will readily appreciate that the present invention is well adapted to carry out the objects and obtain the ends and advantages mentioned, as well as those inherent therein. While the invention has been disclosed with reference to specific embodiments, it is apparent that other embodiments and variations of this invention may be devised by others skilled in the art without departing from the true spirit and scope used in the practice of the present invention. The appended claims are intended to be construed to include all such embodiments and equivalent variations.

What is claimed:

1. A method of separating polycarbonate from a polycarbonate-containing plastic swarf, the method comprising (a) contacting a polycarbonate-containing plastic swarf sample with a first volume of a solvent, thus forming a mixture comprising a supernatant and a solid residue, and (b) separating the supernatant from the solid residue, wherein the supernatant comprises at least a fraction of the polycarbonate comprised in the plastic swarf sample, wherein the solvent comprises at least one selected from the group consisting of dichloromethane, tetrahydrofuran chloroform, 1,2-dichloroethane, 1,4-dioxane, dimethylformamide, dimethylacetamide, benzene, toluene, xylene and chlorobenzene.

2. The method of claim 1, wherein the polycarbonate-containing plastic swarf melts with at least partial decomposition.

3. The method of claim 1, wherein the polycarbonate-containing plastic swarf undergoes no significant melting or only partial melting.

4. The method of claim 1, wherein the solid residue in (b) is subjected to one or more cycles of steps (a)-(b), wherein for each cycle the supernatant in (b) comprises at least a fraction of the polycarbonate comprised in the plastic swarf sample and the solid residue in (b) is used as the sample in step (a) of the next cycle, if applicable.

5. The method of claim 4, wherein the supernatants separated in each cycle are combined to generate a polycarbonate-containing solution.

6. The method of claim 4, wherein the solid residue in (b) is subjected to one or more cycles of steps (a)-(b) until the weight of the solid residue remains approximately the same after two consecutive cycles.

7. The method of claim 1, wherein the plastic swarf comprises at least one selected from the group consisting of bisphenol A, 1,1-bis(4-hydroxyphenyl)cyclohexane, dihydroxybenzophenone, tetrabromobisphenol A and tetramethylcyclobutanediol.

8. The method of claim 1, wherein the solvent in (a) at a temperature ranging from room temperature to about the solvent's boiling point.

9. The method of claim 8, wherein the solvent in (a) at a temperature of about the solvent's boiling point.

10. The method of claim 1, wherein the polycarbonate-containing plastic swarf sample is in a container that is permeable to the solvent but not to the sample or solid residue, thus allowing for the filtration of the supernatant off the sample or solid residue.

11. The method of claim 1, wherein the solvent is heated in a reservoir thus forming solvent vapor, and wherein the solvent vapor is condensed onto the sample.

12. The method of claim 11, wherein the supernatant is drained into the reservoir.

13. The method of claim 1, wherein the method is performed using a Soxhlet extraction set-up.

14. The method of claim 1, wherein the supernatant is at least partially concentrated to provide solid polycarbonate.

15. The method of claim 14, wherein the solid polycarbonate is suitable for at least one selected from the group consisting of extrusion, 3D printing and hot pressing.

16. The method of claim 14, wherein the concentration allows for formation of a substantially or fully transparent polycarbonate film.

17. The method of claim 14, wherein the concentration comprises solvent evaporation at about atmospheric pressure.

18. The method of claim 1, wherein, before implementing step (a), the plastic swarf is contacted with a purifying solvent form a solution and a solid residue, wherein the solid residue was dried and used as the sample in step (a).

19. The method of claim 1, wherein, before implementing step (a), the plastic swarf is contacted with chloroform to form a chloroform-containing solution, wherein any non-soluble residue present is discarded and wherein the chloroform-containing solution is concentrated to provide the sample in step (a).

20. The method of claim 1, wherein, before implementing step (a), the plastic swarf is washed with an aqueous acidic solution and then used as the sample in step (a).

21. The method of claim 18, wherein the solid residue is substantially free of color.

22. A method of preparing a transparent polycarbonate film, the method comprising allowing a polycarbonate solution in a solvent comprising at least one selected from the group consisting of dichloromethane, tetrahydrofuran, chloroform, 1,2-dichloroethane, 1,4-dioxane, benzene and toluene to evaporate, whereby a transparent polycarbonate film forms.

23. The method of claim 22, wherein the polycarbonate solution is prepared from plastic swarf using the method of claim 1.

24. A method of forming a hybrid polycarbonate-polyimine material, the method comprising contacting a polycarbonate with a polyimine in a reaction solution.

25. The method of claim 24, wherein the polyimine is formed in situ by contacting a polyaldehyde with a polyamine in the reaction solution.

26. The method of claim 24, wherein the polyimine is preformed by contacting a polyaldehyde with a polyamine and then added to the reaction solution.

27. The method of claim 24, wherein the polyamine is at least one selected from the group consisting of hydrazine, ethylenediamine, propylenediamine, 1,4-diaminobutane, 1,5-diaminopentane, 1,6-diaminohexane, 1,7-diaminoheptane, 1,8-diaminooctane, 1,9-diaminononane, 1,10-diaminodecane, 1,12-diaminododecane, 3,3′-diamino-N-methyl-dipropylamine, phenylenediamine, phenylenedimethylenamine, diaminocyclohexane, diaminocyclopentane, diaminocyclobutane, diaminothiophene, diaminopyridine, diaminopyrrole, diaminofuran, diaminoimidazole, diaminooxazole, 3,6,9-trioxaundecan-1,11-diamine, diethylenetriamine, tris(2-aminoethyl)amine, 3-ethylamino-1,5-diaminopentane, triaminobenzene, and triaminocyclohexane.

28. The method of claim 24, wherein the polyaldehyde is at least one selected from the group consisting of glyoxal, malonaldehyde, glutaraldehyde, 2,3-thiophenedicarbaldehyde, 2,5-thiophene-dicarbaldehyde, 3-formylfurfural, 5-formylfurfural, 2,6-pyridinedicarboxaldehyde, 3,6-pyridinedicarboxaldehyde, 3,5-pyridinedicarboxaldehyde, isophthaldehyde, terephthaldehyde], phthaldialdehyde, phenylglyoxal, pyrroledicarboxaldehyde, benzene-1,3,5-tricarboxaldehyde, and 2,4,6-trihydroxy-1,3,5-benzenetricarboxaldehyde.

29. The method of claim 24, wherein the ratio between the polyaldehyde and polyamine ranges from about 10:90 to about 90:10.

30. The method of claim 24, wherein the ratio between the polyaldehyde and polyamine ranges from about 25:75 to about 75:25.
